(19) United States
(12) Patent Application Publication
(10) Pub. No.: US 2007/0295185 A1
(43) Pub. Date: Dec. 27, 2007

(54) Adjustable bench for saw machine

(75) Inventor: Jung-Hua Lin, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Yung Li Hsing Electric Works Co., Ltd, Tan Tsu Country (TW)

(21) Appl. No.: 11/485,288

(22) Filed: Jul. 13, 2006

(30) Foreign Application Priority Data
Jun. 22, 2006 (TW) 95210946

(51) Int. Cl. B23D 55/02

(52) U.S. Cl. 83/810

(57) ABSTRACT

An adjust bench for saw machine, comprising: A saw machine has a wheel in the up side and a wheel in the down side. A band saw puts around those two wheels. A motor mounts inside the saw machine for driving the wheels. A bench has a through-hole for passing through the band saw. There are two adjust devices on the button side of the bench for adjusting the angle of inclination. The bench has an observing window thereon and beside the through-hole. An arc gear row that sets beside the arc guider bends upward and extends from the saw machine. A scale wheel pivots at the button side of the bench and beside the arc portion. There are scales around the surface of the scale wheel. The user can observe the scale from the observing window. There is a gear wheel beside the scale wheel and gears with the arc gear row.

### BACKGROUND OF THE INVENTION

1. Field of the Invention

The present invention relates to a saw machine and more particularly to an adjustable bench for saw machine.

2. Description of the Related Art

A saw machine in the market now always has a bench pivoted on it and the angle of inclination of the bench is adjustable. There are many different structures for adjusting the angle of inclination in those different types of the saw machine in the market. So far, those structures for adjusting the angle of inclination have some common problems. First, most of those prior art structures use wire-control as a main structures to adjust the angle and this control mode occurs a big inaccuracy with the fact angle of inclination usually. The second problem is about the convenience of operation. All of those adjust structures and the guide rule mounted under the bench in most of the prior art and the bench will block the sight. So, operator can not observe the angle of inclination directly from the top of the bench. In order to know the angle, operator has to bend down for checking the scale. This is a very inconvenience operation method.

### SUMMARY OF THE INVENTION

The object of the present invention is to provide an easy operating and adjustable bench for saw machine.

To achieve this object of the present invention, an adjustable bench for saw machine includes a saw machine has a wheel in the up side and a wheel in the down side. A band saw puts around those two wheels. A motor mounts inside the saw machine for driving the wheels. A bench has a through-hole for passing through the band saw. There are two adjust devices on the button side of the bench for adjusting the angle of inclination. The bench has an observing window thereon and beside the through-hole. An arc gear row that sets beside the arc guider bends upward and extends from the saw machine. A scale wheel pivots at the button side of the bench and beside the arc portion. There are scales around the surface of the scale wheel. The scales can be observed from the observing window directory. There is a gear wheel beside the scale wheel and gears with the arc gear row.

### BRIEF DESCRIPTION OF THE DRAWINGS

FIG. 1 is an outside shape view of the present invention;

FIG. 2 is a side view of the present invention;

FIG. 3 is a partial detail view of the adjust devices of present invention;

### DETAILED DESCRIPTION OF THE INVENTION

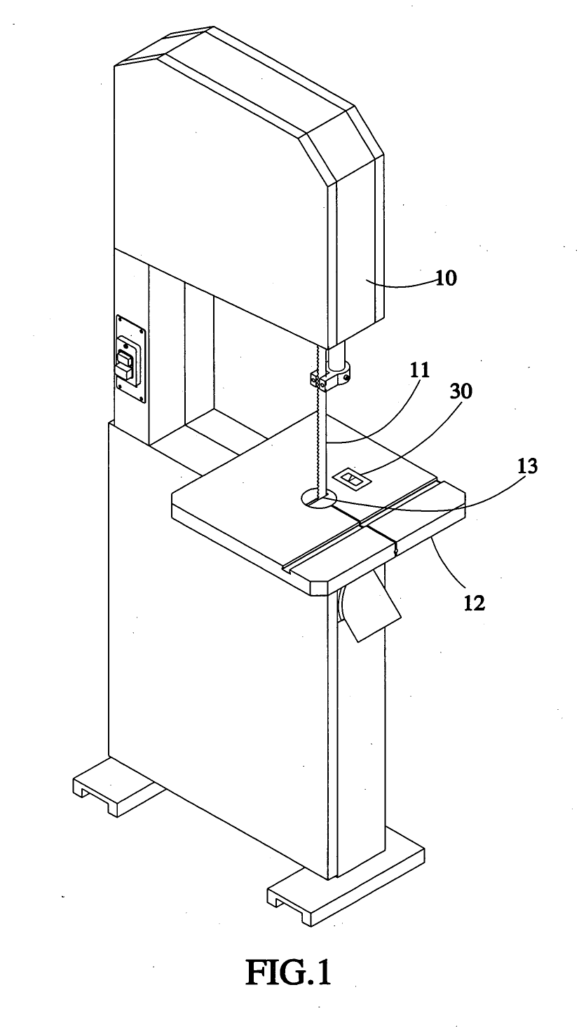

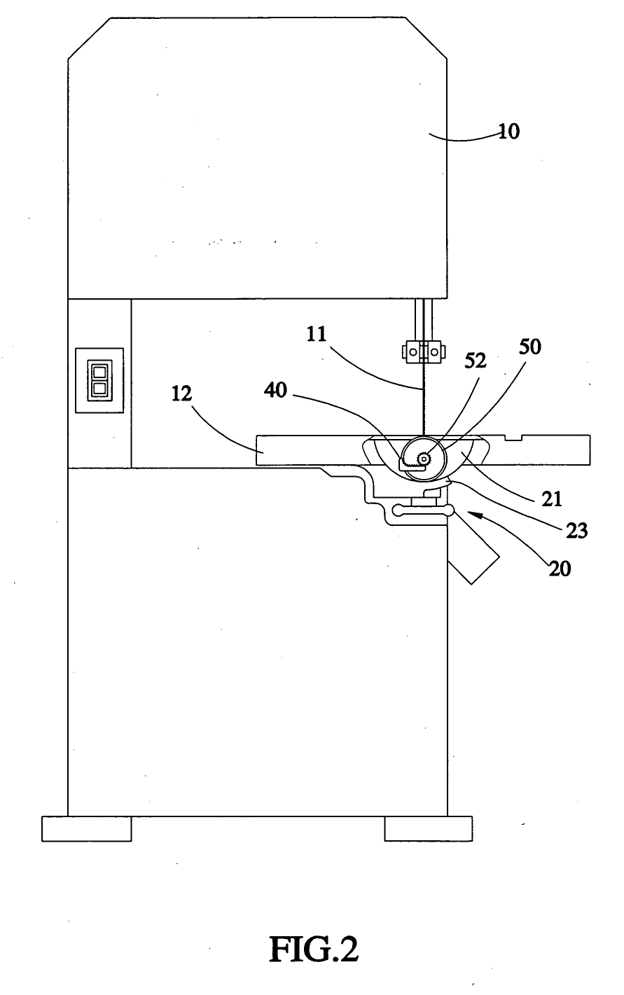

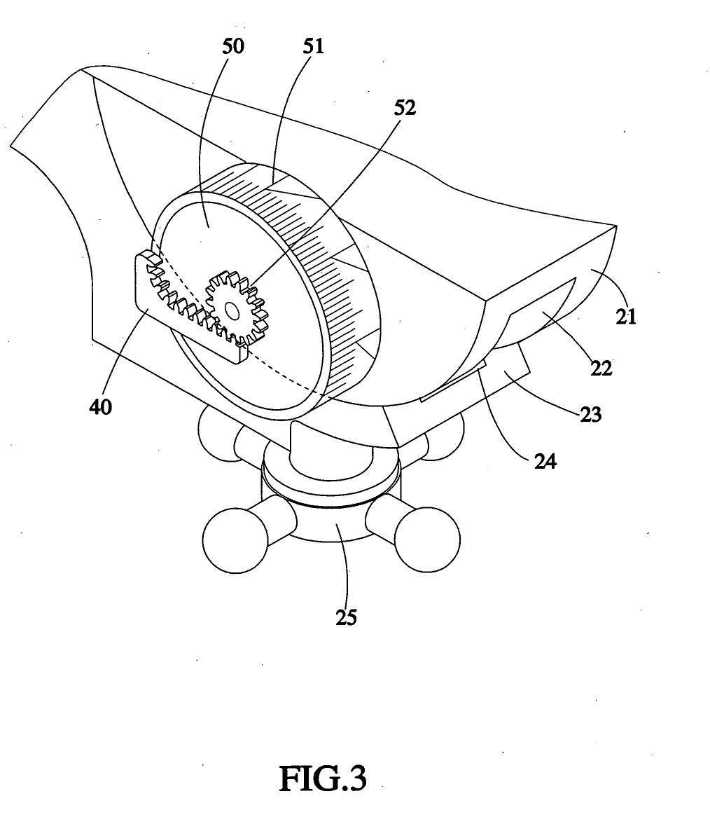

Referring to FIG. 1 to FIG. 3, an adjustable bench for saw machine of present invention includes:

A saw machine 10 has a wheel in the upper side and a wheel in the down side (not shows in FIGS.). A band saw puts around those two wheels. A motor (not shows in FIGS.) mounts inside the saw machine for driving the wheels. A bench 12 has a through-hole 13 thereon for passing through the band saw. There are two adjust devices on the button side of the bench. In this embodiment of present invention, the adjust devices are two arc portions 21 and two arc guiders 23. The arc portions 21 protruding from the bench 12 and each of the arc portions has a trough 22 along the long axis of the arc portion. The arc guiders 23 with a slide hole 24 bend upward and extend from the saw machine. The bench 12 sets on these tow arc guiders 23 and a bolt pass through each corresponding slide hole and trough to fix the bench. The characters of present invention are:

The bench has an observing window 30 thereon and beside the through-hole 13.

An arc gear row 40 that sets beside the arc guider 23 bends upward and extends from the saw machine.

A scale wheel 50 pivots at the button side of the bench 12 and beside the arc portion 21. There are scales 51 around the surface of the scale wheel 50. The user can observe the scale from the observing window. There is a gear wheel 52 beside the scale wheel and gears with the arc gear row 40.

As aforesaid structures disclosed, the user need to release those two adjusting devices 20 and slid the bench 12 to the desired angle when user wants to adjust the angle of inclination. In this embodiment of present invention, user needs to release those two bolts 25 and slid the bench 12 to the desired angle. By the way, the bench can slid along the curve of the arc guider 23. Then, the bench 12 can be fixed by those two bolts in the operation angle. At the same time, the gear wheel 52 will gear with the arc gear row 40 and force the scale wheel 50 to rotate. The user can observe the scale 51 of the scale wheel from the observing window 30 directly. In this operation method, user can slide the bench to a desired angle easily without bending down the body and the angle of inclination of the bench will be more accuracy than prior art.

What is claimed is:

1. An adjust bench for saw machine, comprising:
a saw machine has a wheel in the up side and a wheel in the down side; a band saw puts around those two wheels; a motor mounts inside the saw machine for driving the wheels; a bench has a through-hole for passing through the band saw. There are two arc portions and two arc guiders under the bench; the arc portions protruding from the bench and each arc portions has a trough along the long axis of the arc portion; the arc guiders with a slide hole bend upward and extend from the saw machine; the bench sets on these tow arc guiders and a bolt pass through each slide hole and trough to fix the bench; the characters of present invention are:
the bench has an observing window locates thereon and beside the through-hole;
an arc gear row bends upward and extends from the saw machine;
a scale wheel pivots at the button side of the bench and beside the arc portion; there are scales around the surface of the scale wheel and the user can observe the scale from the observing window; there is a gear wheel beside the scale wheel and gears with the arc gear row.

2. The adjust bench for saw machine as claimed in claim 1, wherein the arc gear row sets beside the arc guider.

3. An adjust bench for saw machine, comprising:
a saw machine has a wheel in the up side and a wheel in the down side; a band saw puts around those two wheels; a motor mounts inside the saw machine for driving the wheels; a bench has a through-hole for passing through the band saw; there are two adjust devices on the button side of the bench for adjusting the angle of inclination; the characters of present invention are:
the bench has an observing window thereon and beside the through-hole;
an arc gear row that sets beside the arc guider bends upward and extends from the saw machine;
a scale wheel pivots at the button side of the bench and beside the arc portion; there are scales around the surface of the scale wheel; The scales can be observed from the observing window directory; there is a gear wheel beside the scale wheel and gears with the arc gear row.

4. The adjust bench for saw machine as claimed in claim 3, wherein the adjust device includes two arc portions and two arc guiders; the arc portions protruding from the bench and each arc portions has a trough along the long axis of the arc portion; the arc guiders with a slide hole bend upward and extend from the saw machine; the bench sets on these tow arc guiders and a bolt pass through each slide hole and trough to fix the bench.
